(19) United States
(12) Patent Application Publication
(10) Pub. No.: US 2009/0037402 A1
(43) Pub. Date: Feb. 5, 2009

(54) SYSTEM AND METHOD FOR PREDICTING CLICKTHROUGH RATES AND RELEVANCE

(76) Inventors: Rosie Jones, Pasadena, CA (US); Ben Carterette, Amherst, MA (US)

Correspondence Address: YAHOO! INC.;C/O DREIER LLP, 499 PARK AVENUE, NEW YORK, NY, 10022, US

(21) Appl. No.: 11/831,872

(22) Filed: Jul. 31, 2007

(51) Int. Cl. G06F 17/30

(52) U.S. Cl. 707/5; 707/E17.14

(57) ABSTRACT

Systems and methods according to embodiments leverage click data to predict a relevance judgment for a given query-content item pair. An initial training phase utilize a training set of query-content item pairs coupled with click data and relevance data (e.g., relevance judgments or labels) to train a model of the relationship between relevance and clicks. Accordingly, given an unlabeled query-content item pair as input to the model, a relevance judgment or label is provided. Theses relevance labels, in turn, may be used in conjunction with query-content item pairs with which they are associated to train a model to determine a content item relevance function. When a user provides a query to a given search engine, the search engine applies the content item relevance function to the query and content items in a responsive result set to provide a relevance ordered result set to the user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to predicting the clickthrough rate of a given content item on the basis of one or more relevance judgments and predicting the relevance of a content item on the basis of the clickthrough rate of the given content item and zero or more other content items shown to the user in conjunction with the given content item. According to one embodiment, the invention relates to leveraging clickthrough data on one or more search result pages that the search engine generates in response to one or more search queries to predict the relevance of a given content item included as part of a given search results page. Systems and methods according to embodiments of the present invention may use these data to evaluate the performance of a given search engine in comparison to a second search engine or disparate version of the given search engine.

### BACKGROUND OF THE INVENTION

An important, but often overlooked, aspect of search engine design and performance is evaluation. Evaluation, however, is an expensive, cumbersome and time consuming process because it requires relevance judgments that indicate the degree of relevance of a given content item retrieved for a given query in a training set. A corpus such as the web, however, contains billions of content items. While it is sufficient to judge a sample of these content items for a statistical estimate of relevance, judgments are costly in terms of human time; more judgments lead to more reliable estimates of relevance.

Even beyond the sheer size of the corpus, web evaluation presents a number of special challenges. For example, the corpus is in constant flux, changing as new content items appear, disappear, become obsolete and the distributions of queries that users are entering change. This requires additional effort since new content items must be continually judged and new queries must be put into the test set. Because such relevance judgments must be updated, over time the process incurs a significant expense.

Search engines, however, have a readily available source of data that may be leveraged to approximate relevance judgments—clicks. When a user enters a query and clicks on a link in the result set, he or she is making a form of relevance judgment on the basis of the information that the search engine provides, e.g., the abstract for the content item. Although clicks are a noisy source of data, they may provide valuable information about the relevance of a given content item when viewed in the aggregate.

The general problem with using clicks as relevance judgments, however, is that clicks are biased. For example, clicks are biased by rank whereby users click higher ranked results more often, by other results on the page whereby a highly relevant content item at rank two will result in fewer clicks at rank one, trust in the sponsor of a link (where applicable), as well as other factors. This means that attempting to learn relevance judgments from click data results in learning these biases that are present in the click data. For example, without removing bias, a clickthrough analysis would indicate that the top-ranked content item is always best, since users click this content item most frequently.

Thus, systems and methods are needed that model clicks vis-à-vis relevance such that by conditioning on clicks, embodiments of the present invention may predict the relevance of a content item or set of content items to a given query. Systems and methods are also needed that model relevance vis-à-vis clicks to predict a clickthrough rate for a given content item where the relevance for the content item is known.

### SUMMARY OF THE INVENTION

Systems and methods according to embodiments of the present invention leverage click data to predict the relevance value or judgment for a given query-content item pair. An initial training phase utilizes a training set of query-content item pairs coupled with click data and relevance data (e.g., relevance judgments or labels) to train a model of the relationship between relevance and clicks. Accordingly, given an unlabeled query-content item pair as input to the model, a relevance judgment or label is provided. Theses relevance labels, in turn, may be used in conjunction with query-content item pairs with which they are associated to train a model to determine a content item relevance function. When a user provides a query to a given search engine, the search engine applies the content item relevance function to the query and content items in a responsive result set to provide a relevance ordered result set to the user.

Embodiments of the present invention may use click data and relevance data to evaluate the performance of a given search engine in comparison to a second search engine or disparate version of the given search engine (e.g., two disparate content item relevance functions). One embodiment contemplates the use of discounted cumulative gain (“DCG”) to evaluate the performance of a given search engine. Using click data trained in accordance with relevance data, embodiments of the invention estimate the confidence that a difference in DCG exists between two rankings on the basis of click information and without having any relevance judgments for the content items in the rankings. Systems and methods are also provided to guide the selection of additional content items to judge to improve confidence.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating a system for determining relevance of a content item to a query from clicks on links to one or more content items on a search result page or vice versa according to one embodiment of the present invention;

FIG. 2 presents a flow diagram illustrating a method for determining and applying a content item relevance function according to one embodiment of the present invention; and

FIG. 3 presents a flow diagram illustrating a method for evaluation the performance of two or more search engines according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

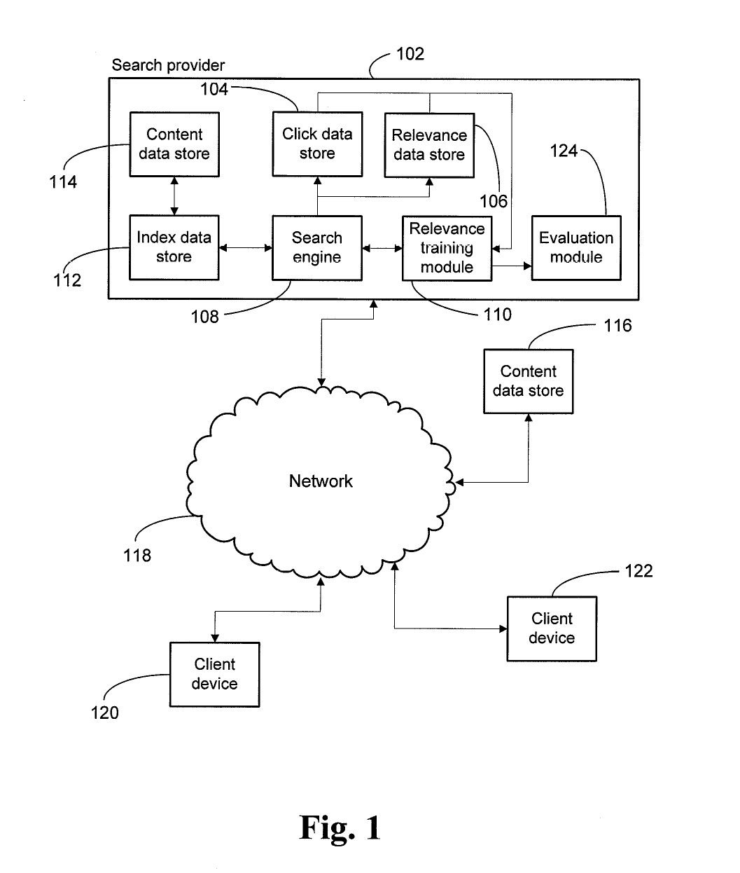

FIG. 1 presents a block diagram depicting a system for determining relevance of a content item to a query from clicks on a link to the content item on a search result page or vice versa. The embodiment of the system according to FIG. 1 comprises a search provider 102, one or more content data store 116, a network 118 and one or more client devices 120 and 122. The network may be a combination of one or more wired or wireless, local or wide area networks, such as the Internet. According to one embodiment, a given content data store 116 comprises a standard web or application server as is known to those of skill in the art, e.g., Apache, Microsoft IIS, etc. There is no limitation to be implied with regard to the types and substance of data that a given content data store 116 is operative to maintain.

The one or more client devices 120 and 122 are communicatively coupled to a network 118. According to one embodiment of the invention, a given client device 120 and 122 is general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

Also in communication with the network 118 is a search provider 102. According to one embodiment, the search provider 102 comprises a search engine 108, an index data store 112, a click data store 104, a relevance data store 106, a relevance training module 110 and a content data store 114. The search engine 108 may operate in accordance with information retrieval techniques known to those of skill in the art. For example, the search engine 108 may be operative to maintain an index in the index data store 112, the index comprising a list of word-location pairs (in addition to other data). When the search engine 108 receives a query, the search engine traverses the index at the index data store 112 to identify content items that are relevant to the query, e.g., those content items that comprise the query terms. The index at the index data store 112 may be operative to index content items located at both local and remote content data stores, 114 and 116, respectively. As is described in greater detail herein, the search engine 108 may use systems and methods in accordance with embodiments of the present invention to determine the relevance of a given content item to a given query to use in selecting and ranking content items for display to a user issuing the given query.

The search provider 102 may maintain one or more local or remote data stores. According to one embodiment, the search provider 102 maintains a click data store 104 and a relevance data store 106. The relevance data store 106 maintains one or more records that indicate a relevance judgment for a given query-content item pair. For example, a given record in the relevance data store 106 may indicate that the query term “patent” and the content item at the address “www.uspto.gov” are highly relevant to each other. According to one embodiment, relevance takes the form of a set of ordinal values that indicate decreasing order of relevance, e.g., 1=highly relevant, 2=somewhat relevant, 3=relevant, 4=less relevant and 5=not relevant. Those of skill in the art recognize that other alternative scales could be used in place of, or in conjunction with, those described herein.

Relevance data or information in the relevance data store 106 according to one embodiment may comprise relevance judgments made by a staff of assessors that the search provider 102 may employ. According to one embodiment, a set of one more queries may be randomly selected to form the basis for the relevance information in the relevance data store 106. Assessors may determine relevance judgments from instructions regarding how to interpret queries, guidelines for a given level of relevance, etc. They may also be provided with a sample set of click results to provide a given assessor context regarding user intent. Furthermore, measurements of inter-assessor agreement may be computed for storage in the relevance data store 106.

As indicated above the search provider may maintain a click data store 104. The click data store is operative to interface with the search engine 108 and maintain a record of query and click information, which may comprise additional information regarding a query session for a given user. According to one embodiment, the click data store is operative to maintain a query, a search identification string, a canonicalized query, a content item identifier, the rank at which the search engine displays the content item, and whether the user selects (clicks) the content item. For example, where the user enters the query “monster.com” and receives a result set comprising links to twelve content items, the click data store 106 is operative to generate and maintain twelve records: one record for the result at each rank. Further according to this embodiment, each record in the click data store 106 would comprise the same query, search identification string and canonicalized query, but different content item identifiers and ranks.

The click data store 104 may be operative to aggregate records contained therein into distinct lists of content items for a given query. According to one embodiment, records are first aggregated by query and search identification string, so for a given query/search ID the click data store maintains a list, L, of content items that were selected for presentation to the user and which (if any) were selected by the user. The click data store also aggregates Ls over search Ids, λ, which provides the number of times L was displayed to all users who entered the same canonical query and the number of times each content item in L was displayed. Those of skill in the art may view λ as an ordered set in which a given element may be a count of clicks on the link to the content item at the corresponding rank, which may also include a number of views of the link to the content item, e.g., impressions. The click data store may calculate the clickthrough rate as the count in L divided by the number of impressions (the number of times L was shown to any user). Those of skill in the art of statistical estimation recognize that statistical priors or smoothing may be used to improve the estimate or calculation of the clickthrough rate.

The search provider 102 in accordance with one embodiment of the present invention comprises a relevance training module 110, which according to one embodiment is operative to predict the relevance of a content item on the basis of a clickthrough rate for the content item and zero or more other content items shown in conjunction with the content item. The relevance training module 110 may obtain clickthrough and relevance information from the click data store and the relevance data store, 104 and 106, respectively. Embodiments also contemplate predicting the clickthrough rate for a content item on the basis of the relevance of the content item. The relevance training module 110 models the relationship between clicks and relevance to allow for the estimation of a distribution of the relevance p(Xᵢ) from the clicks on content item i and on content items that the search provider presents in conjunction with content item i.

The relevance training module 110 may utilize a joint probability distribution including a query q, a relevance measure Xᵢ for content items that the search provider 102 retrieves in response to the query (where i indicates the rank), and respective clickthrough rates for the content items cᵢ as set forth in Table A:

TABLE A
P(q, X₁, X₂, . . . , Xₗ, c₁, c₂, . . . , cₗ = P(q, X, c)

The variables X and c, which the Table A presents in boldface, indicate vectors of length l. Where the search provider 102 is missing information regarding clicks in the click data store 104 but has information regarding relevance in the relevance data store 106 or the search provider 102 is missing information regarding relevance but has information regarding clicks, the relevance training module 110 is operative to infer the missing information by training models that the relevance training module 110 conditions on different subsets of the data as set forth in Table B:

TABLE B

p(c|q, X) - to predict clicks from relevance and the query
p(X|q, c) - to predict relevance from clicks and the query

Situations exist where the search provider 102 receives a query for which no relevance judgments are available in the relevance data store 106. The situation may exist, for example, where the query has only recently begin to appear in query logs that the search provider 102 maintains, because it reflects an information retrieval trend and numerous new content items concerning the query are appearing in the corpus that the search provider is indexing, etc. The relevance training module 110 may utilize click data in the click data store 104 to predict relevance. Accordingly, the relevance training module 110 is operative to determine the conditional probability p (X|q, c).

As described above, the value X represents a vector of ordinal values, X={X₁, X₂, . . . }. According to one embodiment, a given Xᵢ may take on five values, which the relevance training module 110 may rank from best to worst. As conducting inference on such a model is a complex calculation, the relevance training module 110 makes the assumption that the relevance of content item i and content item j are conditionally independent given a given query and given set of clickthrough rates as Table C indicates:

TABLE C
$p ( X \text{\textbar} q , c ) = {\prod }_{i = 1}^{𝓁} p ( {X}_{i} \text{\textbar} q , c )$

The equation at Table C provides the relevance training module 110 with a separate model for each rank at which the search engine 108 may place a content item in a result set in response to a given query q. The equation at Table C conditions the relevance at rank i on the clickthrough rates at all of the ranks without the losing the dependence between relevance at each rank and clickthrough rates on other ranks.

The independence assumption allows the relevance training module 110 to model p(Xᵢ) using ordinal regression. Ordinal regression is a generalization of logistic regression to a variable with more than two outcomes that may be ranked in accordance with a preference. Implementations of proportional odds logistic regression may be found in the software package “R,” which is known to those of skill in the art. According to one embodiment, Table D illustrates the proportional odds model that the relevance training module 110 uses for the ordinal response variable:

TABLE D
$log \frac{p ( X > {a}_{j} \text{\textbar} q , c )}{p ( X \leq {a}_{j} \text{\textbar} q , c )} = {α}_{j} + βq + {\sum }_{i = 1}^{𝓁} {β}_{i} {c}_{i} + {\sum }_{i < k}^{𝓁} {β}_{ik} {c}_{i} {c}_{k}$

According to the equation of Table D, αⱼ is one of the five relevance levels. The summations are over all ranks in the list, which models the dependence of the relevance of a given content item to the clickthrough rates of all other content items that the search engine 108 retrieves. Additionally, the equation of Table D is operative to model the dependence between the clickthrough rates at any two given ranks. The relevance training module 110 may learn the coefficients βᵢ and βᵢₖ according to one embodiment by likelihood maximization using iteratively reweighted least squares (“IRLS”). Additionally, there are five intercepts αⱼ, which the relevance training module 110 may learn by a variant of Newton's method. After the relevance training module 110 trains the model, p(X<=aⱼ|q, c) using the inverse logit function. Accordingly, p=X=aⱼ|q, c)=p(X<=aⱼ|q, c)−p(X<=aⱼ₋₁|q, c).

The use of ordinal regression according to various embodiments of the invention may require a linear relationship between relevance and clickthrough rates. When utilizing some data sets, there are situations where no such relationship exists. Instead, for example, relevant content items may be clicked on more than twice as often as less relevant content items. Accordingly the relevance training module 110 may utilize a vector generalized additive model (“VGAM”), which is a generalization of ordinal regression. According to one embodiment, the relevance training module 110 utilizes the general from of the VGAM as Table E illustrates:

TABLE E
$log \frac{p ( X > {a}_{j} \text{\textbar} q , c )}{p ( X \leq {a}_{j} \text{\textbar} q , c )} = {α}_{j} + f ( q , c )$

According to the equation of Table E, f is a smoothing function (which according to one embodiment is fit by a method such as piecewise regression) that allows the VGAM to model nonlinearity and dependencies. Where the relevance training module 110 executes the smoothing function through the use of piecewise regression, the relevance training module 110 breaks the smoothing function into additive components. Table F illustrates the breakdown of the smoothing function into additive components:

TABLE F
$log \frac{p ( X > {a}_{j} \text{\textbar} q , c )}{p ( X \leq {a}_{j} \text{\textbar} q , c )} = {α}_{j} + s ( q ) + {\sum }_{i = 1}^{𝓁} {f}_{i} ( {c}_{i} ) + {\sum }_{i < k}^{𝓁} {g}_{ik} ( {c}_{i} {c}_{k} )$

By breaking the smoothing function into additive components, the relevance training module 110 requires less data to fit the model and significantly reduces any overfitting. Once the relevance training module 110 trains the model, it may calculate p(X=aⱼ) using the same arithmetic as for the proportional odds model at Table D.

In addition to modeling relevance from clicks, the relevance training module 110 in accordance with embodiments of the invention is operative to model clickthrough rates for a given content item on the basis of a relevance score or judgment for the given content item. To model p(c|q, X), which provides a prediction of a clickthrough rate for a given content item on the basis of one or more relevance judgments and a query, the relevance training module 110 may utilize a logistic regression. Alternatively, the relevance training module 110 may utilize a generalized additive model (“GAM”), which may subsume a logistic regression as GAM is a generalization to logistic regression.

By fitting a function to a variable, or to a plurality of variables, the relevance training module 110 may use a GAM to model non-linear relationships as well as dependencies between variables. The general form of a GAM that predicts a binary response y from vector Z=(z₁, z₂, . . . ) is:

TABLE G
$log \frac{p ( y \text{\textbar} Z )}{1 - p ( y \text{\textbar} Z )} = {α}_{0} + f ( Z )$

where f is a smoothing function that may be fir by a method such as piecewise regression. By utilizing f the relevance training module 110 may use the GAM to model nonlinearity and dependencies.

The output of the relevance training module 110 may be used to perform an evaluation of two or more search engines, which an evaluation module 124 performs in accordance with the embodiment of FIG. 1. The evaluation module 124 may utilize the discounted cumulative gain (“DCG”) evaluation metric, which the evaluation module 124 performs using click data to estimate a confidence that a difference in DCG exists between two search engine without having relevance judgments for at least some content items in the corpus over which a given search engine is operative to conduct a search. Additionally, the evaluation module 124 may implement an algorithm for the selection of additional content items to judge to thereby improve the confidence. A comparison between two search engines may comprise an output of a first search engine with an output of a second search engine. Alternatively, or in conjunction with the foregoing, the comparison comprises a comparison between a first relevance function and a second relevance function that a given search engine may implement for the selection of content items that are relevant to a given query.

DCG is an evaluation measure frequently used in evaluating web search engines. DCG is a precision-based measure: a search engine under evaluation that ranks content items relevant to a given query highly is rewarded, with the reward discounted as content items get ranked lower. The evaluation module 124 according to one embodiment implements DCG because DCG supports multi-valued relevance judgments. The evaluation module 124 may receive two parameters as input: the maximum rank and the base of the logarithm to use in discounting as Table H illustrates:

TABLE H
${DCG}_{𝓁} = {rel}_{1} + {\sum }_{i = 2}^{𝓁} \frac{{rel}_{i}}{{log}_{2} i}$

The constant rely indicates the relevance of the content item at rank i. As described above, relevance may take the form of a set of ordinal values that indicate decreasing order of relevance. To use these values, the evaluation module 124 maps these constants to allow more relevant content items to contribute more to an overall score for a given search engine. According to one embodiment, the evaluation module 124 maps five levels of relevance, αⱼ, e.g., α₁>α₂>α₃>α₄>α₅.

To determine a difference in DCG for two search engines that are under evaluation, the evaluation module 124 refines DCG to allow for the arbitrary indexing of content items. For example, let rⱼ(i) be the rank at which search engine j retrieves content item i. The evaluation module defines the relationship that Table I illustrates:

TABLE I
${log}_{2}^{𝓁} y = \{ \begin{matrix}1 & y = 1 \\ {log}_{2} y & 1 < y \leq 𝓁 \\ ∞ & y > 𝓁\end{matrix}$
In which the discounted gain gₕ is equal to $\frac{{x}_{i}}{{log}_{2}^{𝓁} {r}_{j} ( i )} ,$ defining $\frac{x}{∞} = 0$

Table H indicates the amount that content item i contributes to the total DCGₗ of search engine j. According to the foregoing, the difference in DCG for a first search engine l1 and a second search engine l2 is as:

TABLE J
$\begin{matrix}{ΔDCG}_{𝓁} = {DCG}_{𝓁1} - {DCG}_{𝓁2} \\ = {\sum }_{i = 1}^{N} {g}_{i 1} - {g}_{i 2}\end{matrix}$

where N is the number of content items in the entire collection.

The evaluation module 124 may define a confidence in a difference in DCG for a first search engine and a second search engine as the probability that ΔDCG=DCG₁-DCG₂ is less than zero. For example, if the P(ΔDCG<0)>=0.95, the evaluation module 124 determines with a 95% confidence that the first search engines performs worse that the second search engine. To compute this probability, the evaluation module 124 according to one embodiment considers the distribution of ΔDCG. To do so, the evaluation module draws relevance scores for ranked content items according to the multinomial distribution p(Xᵢ), which the evaluation module 124 may receive from the relevance training module 110, and calculate ΔDCG using those scores. After T trials, the probability that ΔDCG is less than zero is equal to the number of times ΔDCG was less than zero divided by T.

In certain situations, the evaluation module 124 may require relevance scores or judgments on the basis of clicks from the relevance training module 110 to improve confidence. According to one embodiment, the evaluation module 124 selects content items randomly. Alternatively, or in conjunction with the foregoing, the evaluation module 124 selects content items that provide additional information with regard to ΔDCG. Accordingly, the relevance training module 110 may select those content items that are mathematically informative, while bypassing or discarding those content items that are not mathematically informative.

The most informative content items are those having the greatest impact on ΔDCG. Because ΔDCG is linear, the evaluation module 124 may easily determine a next content item to select for relevance judgment. The evaluation module 124 may acquire relevance judgments iteratively (both on the basis of human judgments, as well as click data) until confidence is sufficiently high, e.g., surpasses a threshold, according to the pseudo code of Table K:

TABLE K

1: while 1 − α ≦ P(ΔDCG < 0) ≦ α do
2: i* ← maxᵢ |E[gᵢ₁] − E[gᵢ₂]|
3: judge document i*
(human annotator provides rel_{i*})
4: P(X_{i*} = rel_{i*}) ← 1
5: P(X_{i*} ≠ rel_{i*}) ← 0
6: estimate P(ΔDCG) using Monte Carlo simulation
7: end while

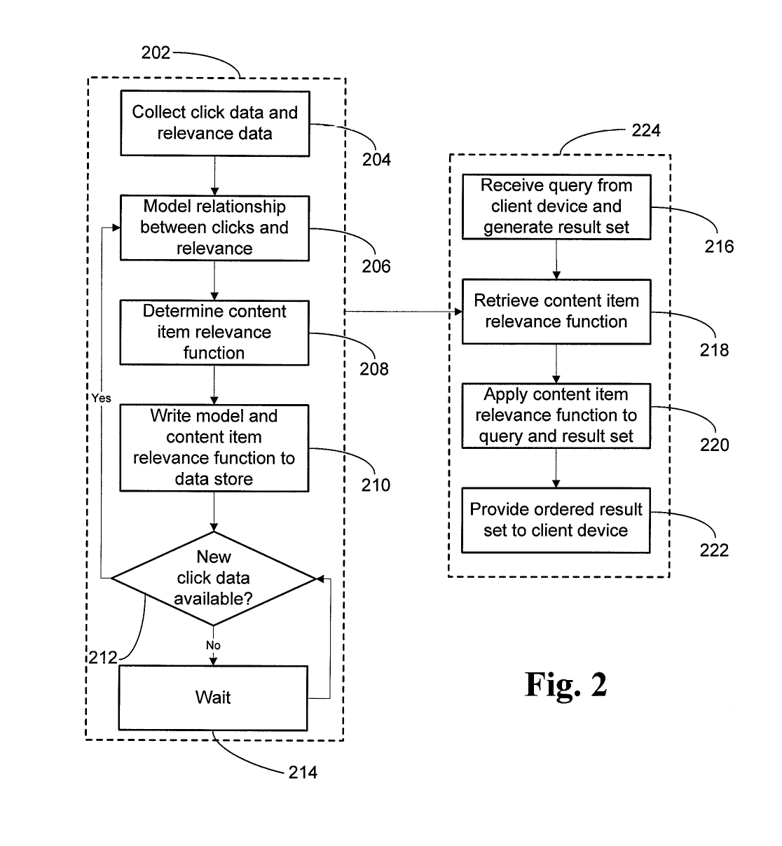

FIG. 2 illustrates one embodiment of a method for implementing the techniques described in connection with FIG. 1. The method according to the embodiment of FIG. 2 comprises an offline process to build a model to determine a content item relevance function, step 202. The offline process, step 202, begins with the collection of click data and relevance data, which may comprise the collection of click data from a search engine and relevance data from human editors or other processes, step 204. The click data that the search engine provides may include the clickthrough rate of a given content item and zero or more other content items shown to the user in conjunction with the given content item, e.g., on a search result page.

A relationship is modeled between clicks and relevance to determine the relevance of a given content item to a given query on the basis of the clicks for the given content item and zero or more other content items shown to the user in conjunction with the given content item, step 206. The model predicts the relationship between clicks and relevance, which a relevance module may utilize to determine a content item relevance function, step 208, which may be used to determine the relevance of an unlabeled content item to a given query.

The relevance module writes the model and the content item relevance function to a data store, step 210, such as a flat file data store (CSV, tab-delimited or other flat file data store), a relational database, an object-oriented database, a hybrid object-relational database or other data store known to those of skill in the art that is operative to maintain data in an organized and structured manner. The offline process, step 202, awakens periodically to determine if there is new click data available for use in further tuning the model, step 212. Where new click data is available, processing returns to step 206 with the relevance module incorporating the new click data into the model, step 206. Where no additional click data is available, step 212, the offline process, step 202, enters a wait state, step 214. At the expiration of a wait period, program flow returns to step 212 with a subsequent check for the availability of new click data.

In addition to the offline process, step 202, the embodiment of the method of FIG. 2 may also comprise an online process, step 224. The online process concerns how the search engine manages the generation of a result set for a query that it receives. Accordingly, the online process may begin with the receipt of a query from a client device and the generation of a result set, step 216, the result set comprising content items (or links thereto) that are responsive to or otherwise fall within the scope of the query. To rank or otherwise order the content items in the result set, the search engine retrieves from the data store the content item relevance function that the offline process determines, step 218.

The search engine receives the content item relevance function, step 218, and applies the content item relevance function to the query and content items in the result set, step 220. According to one embodiment, the content item relevance function is operative to output a relevance for a given query-content item pair. When the search engine enumerates the application of the content item relevance function to the content items in the result set, the search engine may order the content items in the result set according to relevance. In response to the query, the search engine may transmit the ranked or otherwise ordered result set to the client device for use by the user or software process that is issuing the query, step 222, which may include display of the result set on a display of the client device.

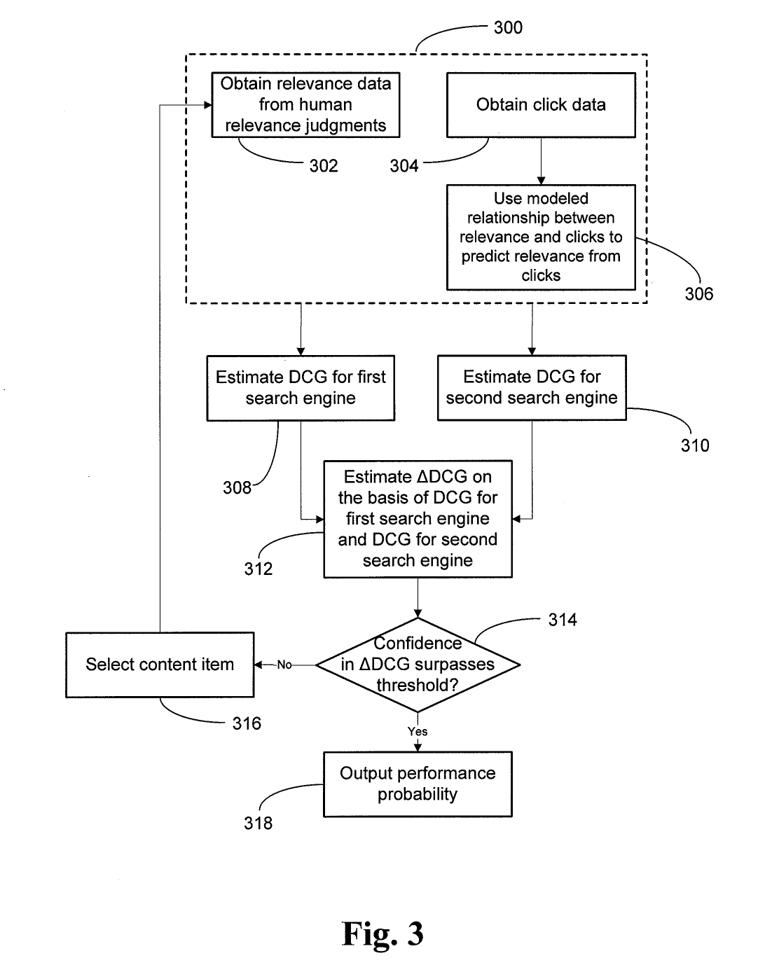

As described herein, systems and methods of the present invention may be utilized to evaluate the relative performance of one or more search engines, which may include evaluating the effectiveness or accuracy of a given content item relevance function that a given search engine is employing. FIG. 3 illustrates one embodiment of a method for determining the comparative performance of one or more search engines, which may comprise the comparative performance of one or more content item relevance functions that a single search engine may implement.

The method according to the embodiment of FIG. 3 begins with a sub-process for obtaining relevance judgments for query-content item pairs in a sample or training set, step 300. According to the sub-process of step 300, for one or more query-content item pairs in the sample or training set, relevance data is obtained from human relevance judgments, step 302. According to one embodiment, human relevance judgments comprise relevance judgments by humans who are experts in determining the relevance of a given query-content item pair, in which the human may make the judgment in accordance with one or more objective rules that guide relevance judgments.

The sub-process also comprises steps to determining the relevance of a given query-content item pair on the basis of the clicks for the content item in response to the query. Obtaining relevance judgments from clicks comprises obtaining click data for one or more query-content item pairs from a sample or training set, step 304. The method uses a modeled relationship between relevance and clicks to predict relevance from clicks, step 306.

The method uses the relevance data obtained on the basis of human judgments in conjunction with relevance judgments derived from clicks (using the modeled relationship between clicks and relevance) to estimate a DCG score for one or more search engines, a given search engine which may implement or otherwise apply disparate content item relevance functions. Accordingly, the output of the sub-process, step 300, is used to estimate a DCG score for a first search engine, which may implement or otherwise apply a first content item relevance function, step 308. the output of the sub-process, step 300, may also be used to estimate a DCG score for a second search engine, which may implement or otherwise apply a second content item relevance function, step 310.

The method determines a ΔDCG, step 312, on the basis of the DCG for the first search engine, step 308, and the DCG for the second search engine, step 310. According to one embodiment, DCG is refined to allow for the arbitrary indexing of content items.

A check is performed to determine if a confidence in ΔDCG surpasses a threshold, step 314. Where the confidence does not surpass the threshold, step 314, continues at step 316 with the iterative selection of a subsequent content item. Processing returns to step 302 with the method obtaining relevance data for the subsequent content item and the process of FIG. 3 repeating. Where the confidence surpasses the threshold, step 314, the probability that the first search engine outperforms or underperforms the second search engine is output, step 318, which may comprise outputting to a display device for review by a human operator or outputting to a software process for further processing or manipulation.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for determining the relative performance of a search engine, the method comprising:
obtaining relevance data and click data;
modeling a relationship between the relevance data and the click data to determine a relevance for a content item on the basis of click data for the content item;
estimating a first DCG for a first search engine using the modeled relationship;
estimating a second DCG for the second search engine using the modeled relationship;
estimating a ΔDCG on the basis of the first DCG and the second DCG; and
if a confidence in ΔDCG surpasses a threshold, outputting a performance probability.

2. The method of claim 1 comprising obtaining the relevance data from human relevance judgments.

3. The method of claim 1 comprising:
if the confidence in ΔDCG does not surpass the threshold, selecting a subsequent content item; and
obtaining relevance data for the selected subsequent content item.

4. The method of claim 1 wherein modeling comprises providing a relevance judgment for a query-content item pair on the basis of clicks.

5. The method of claim 1 wherein the outputting comprises indicating that the first search engine outperforms the second search engine.

6. The method of claim 1 wherein the outputting comprises indicating that the first search engine underperforms the second search engine.

7. Computer readable media comprising program code that when executed by a programmable processor causes execution of a method for determining the relative performance of a search engine, the computer readable media comprising:
program code for obtaining relevance data and click data;
program code for modeling a relationship between the relevance data and the click data to determine a relevance for a content item on the basis of click data for the content item;
program code for estimating a first DCG for a first search engine using the modeled relationship;
program code for estimating a second DCG for the second search engine using the modeled relationship;
program code for estimating a ΔDCG on the basis of the first DCG and the second DCG; and
if a confidence in ΔDCG surpasses a threshold, program code for outputting a performance probability.

8. The computer readable media of claim 7 comprising program code for obtaining the relevance data from human relevance judgments.

9. The computer readable media of claim 7 comprising:
if the confidence in ΔDCG does not surpass the threshold, program code for selecting a subsequent content item; and
program code for obtaining relevance data for the selected subsequent content item.

10. The computer readable media of claim 7 wherein program code for modeling comprises program code for providing a relevance judgment for a query-content item pair on the basis of clicks.

11. The computer readable media of claim 7 wherein the program code for outputting comprises program code for indicating that the first search engine outperforms the second search engine.

12. The computer readable media of claim 7 wherein the program code for outputting comprises program code for indicating that the first search engine underperforms the second search engine.
